(19) United States
(12) Patent Application Publication
(10) Pub. No.: US 2025/0088902 A1
(43) Pub. Date: Mar. 13, 2025

(54) Systems and methods for scheduling of self-backhaul links in Millimeter wave networks

(71) Applicant: Indian Institute of Technology Bombay, Mumbai (IN)

(72) Inventors: Gaurav Sudhir KASBEKAR, Mumbai (IN); Tushar Suresh MURATKAR, Mumbai (IN)

(73) Assignee: Indian Institute of Technology Bombay, Mumbai (IN)

(21) Appl. No.: 18/409,533

(22) Filed: Jan. 10, 2024

(30) Foreign Application Priority Data
Sep. 7, 2023 (IN) 202321060322

(51) Int. Cl. H04W 28/06; H04W 28/08

(52) U.S. Cl. CPC H04W 28/06; H04W 28/0967

(57) ABSTRACT

Embodiments herein focus on reducing latency in mmWave self-backhaul networks. Embodiments herein disclose a queue for holding packets at each types of BSs—at least one fibre-BS and at least one self-backhauled BSs (S-BSs). Embodiments herein schedule BS transmitter-receiver pairs that will transmit in each time slot so as to achieve a low average delay in sending packets from the queues of different S-BSs to the fibre-BS. Embodiments herein disclose scheduling methods and systems that performs scheduling decisions considering the queue length at each S-BS.

### TECHNICAL FIELD

Embodiments disclosed herein relate to millimeter wave networks, and more particularly to managing the scheduling of self-backhaul links in millimeter wave networks.

### BACKGROUND

The Third Generation Partnership Project (3GPP) recognizes the availability of millimeter wave (mmWave) bands for Fifth Generation (5G) and beyond cellular networks as a relief, in the face of the rapidly increasing global mobile traffic, which is now posing significant challenges to the access capacity provided by sub-6 GHz bands.

However, this potential comes at the expense of having to contend with a challenging propagation environment characterized by extremely high path loss and very low propagation across barriers, which include both stationary and non-stationary objects. Due to the presence of barriers, mmWave networks frequently display coverage-limited behavior in real-world situations. Therefore, mmWave cellular networks need small-cell base stations (BSs) to be significantly more densely distributed than in sub-6 GHz cellular networks to ensure high-quality coverage. As a result, operators have to deal with large expenditures if wired (e.g., fibre) backhaul links are used. Release 16 of the 3GPP standards has included a new multi-hop wireless backhaul architecture called self-backhaul to enable the construction of a dense network at a low cost. Currently proposed self-backhauling techniques ignore packet queue lengths at the self-backhauled BSs (S-BSs).

Hence, there is a need in the art for solutions which will overcome the above mentioned drawback(s), among others.

### Objects

The principal object of embodiments herein is to disclose methods and systems for scheduling in mmWave self-backhaul networks with low latency, which considers the arrival and departure of packets in the queue at each of the BSs (which can comprise at least one of a fibre-BS and at least one self-backhauled BSs (S-BSs)).

Another object of embodiments herein is to disclose methods and systems for scheduling in mmWave self-backhaul networks with low latency, wherein BS transmitter-receiver pairs are scheduled so as to transmit in each time slot so as to achieve a low average delay in sending packets from the queues of different S-BSs to a fibre-BS.

Another object of embodiments herein is to disclose methods and systems for scheduling in mmWave self-backhaul networks with low latency, wherein scheduling decisions consider the queue length at each S-BS.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a millimeter wave network, wherein the network comprises of two types of BSs (at least one fibre-BS and a plurality of S-BSs), with a packet queue at each S-BS, according to embodiments as disclosed herein;

FIG. 2 depicts the S-BS, according to embodiments as disclosed herein;

FIG. 3 depicts example links between a plurality of S-BSs (S-BS i, S-BS j, and S-BS k), according to embodiments as disclosed herein; and

FIG. 4 is a flowchart depicting the process of scheduling the self-backhaul links in millimeter wave networks, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and case of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

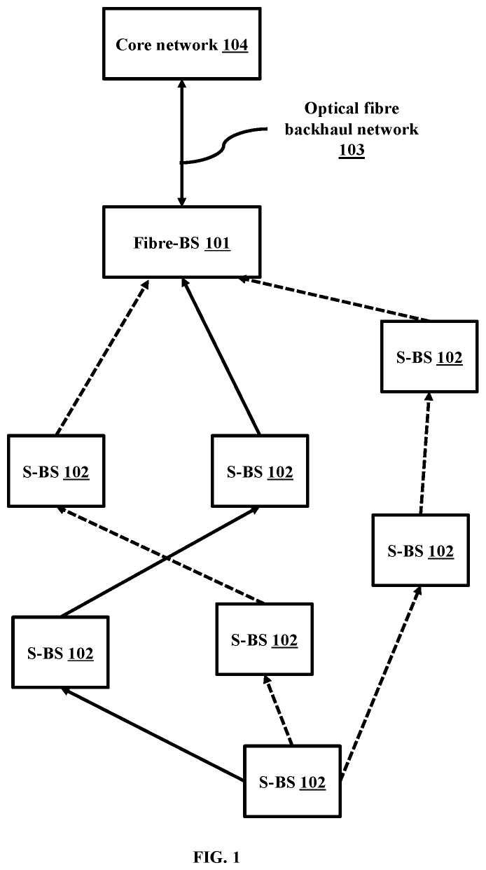

The embodiments herein achieve methods and systems for scheduling in mmWave self-backhaul networks with low latency. Referring now to the drawings, and more particularly to FIGS. 1 through 4, where similar reference characters denote corresponding features consistently throughout the figures, there are shown embodiments.

Embodiments herein disclose methods and systems for scheduling in mm Wave self-backhaul networks with low latency, which considers the arrival and departure of packets in the queue at each of the BSs (which can comprise at least one of a fibre-BS and at least one self-backhauled BSs (S-BSs)). Embodiments herein schedule BS transmitter-receiver pairs so as to transmit in each time slot so as to achieve a low average delay in sending packets from the queues of different S-BSs to a fibre-BS. Embodiments herein can make scheduling decisions by considering the queue length at each S-BS. Embodiments herein can select the set of links that will be activated in each slot, so as to achieve a low average delay in sending packets from different S-BSs to the fibre-BS.

FIG. 1 depicts a millimeter wave network, wherein the network comprises of two types of BSs (at least one Fibre-BS and a plurality of S-BSs), with a packet queue at each S-BS. The millimeter wave network 100, as depicted, comprises at least one fibre-BS 101, and a plurality of self-backhauled BSs (S-BS) 102. The fibre-BS 101 can be further connected to a core network 104, using an optical fibre backhaul network 103. The S-BSs 102 can connect with the fibre-BS 101 through at least one multi-hop wireless link. The fibre-BS 101 can relay data traffic between the S-BSs 102 and the core network 104. All the BSs (which can refer to the fibre-BS 101 and the S-BSs 102) communicate among themselves over millimeter wave (mmWave) frequencies.

Embodiments herein are explained using a network 100 comprising of a fibre-BS 101; however, it may be obvious to a person of ordinary skill in the art that the network 100 may comprise one or more fibre-BSs 101. Embodiments herein use the terms “BS” and “node” interchangeably and can refer to either the S-BS 102 and/or the fibre-BS 101.

Consider that time is divided into slots of equal duration. Additionally, consider that each BS 101, 102 has a single RF chain and hence can only communicate with one other BS 101, 102 within a given time slot.

Each S-BS 102 can have a queue of packets waiting to be forwarded to the core network 104. Further, each S-BS 102 is aware of its queue length (number of packets in its queue) at the start of each time slot. The queue of packets at each S-BS 102 comprises one or more packets. In an embodiment herein, the packets can be sent by users of the network 100, associated with the S-BS 102 to the S-BS 102 for forwarding to the fibre-BS 101. In an embodiment herein, the packets can be sent by other S-BSs 102 to the S-BS 102, via self-backhaul links for forwarding to the fibre-BS 101. Also, the S-BS 102 can monitor each BS's link to each of its neighboring BSs 101, 102, wherein monitoring comprises of determining the channel state of each such link.

Each BS 101, 102 can have a unique identifier. In an embodiment herein, the unique identifier can be a positive integer. Let (i, j) denote the link from BSi to BSj. During initialization, the S-BS 102 can calculate the distance between each S-BS 102 and the fibre-BS 101 in terms of number of hops. In an embodiment herein, the S-BS 102 can calculate the distance between each S-BS 102 and the fibre-BS 101 by executing Dijkstra's algorithm on a network graph with a cost of each link being set to one. In an embodiment herein, the S-BS 102 can calculate the distance between each S-BS 102 and the fibre-BS 101 by executing Bellman-Ford algorithm on a network graph with a cost of each link being set to one. Let hᵢ be the distance, in terms of number of hops, from S-BS i 102 to the fibre-BS 101. During initialization, the value hᵢ of every S-BS i is notified by the fibre-BS 101 to every S-BS 102 in the network.

Embodiments herein denote the queue length at S-BS i by Xᵢ. Also, the measured Signal-to-Noise Ratio (SNR) of the link from i to j is denoted by s_{i,j}.

Consider that a link is activated in a time slot if communication will take place on the link in the slot. Since each BS has a single RF chain, two links that have a node in common cannot be activated in the same time slot. That is, links (i, j) and (k, l) cannot be activated in the same time slot, if i or j equals k or l. Embodiments herein select the set of links that will be activated in each slot, so as to achieve a low average delay in sending packets from different S-BSs to the fibre-BS

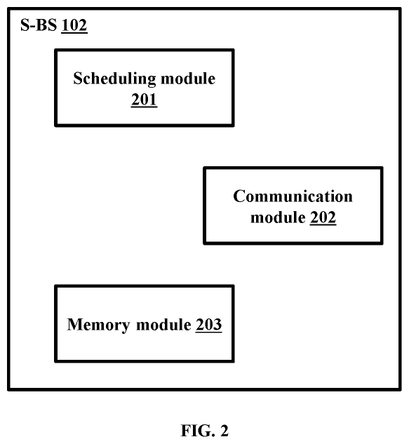

FIG. 2 depicts the S-BS, according to embodiments as disclosed herein. The S-BS 102, as depicted, comprises a scheduling module 201, a communication module 202, and a memory module 203. The communication module 202 may be configured to enable the S-BS 102 to communicate with users, the fibre-BS 101, other S-BSs 102, and so on. Examples of the interface may be, but are not limited to, a mmWave network.

The memory module 203 stores at least one of, the unique identifier, queued packets, data traffic, and so on. Examples of the memory module 203 may be, but are not limited to, NAND, embedded Multimedia Card (eMMC), Secure Digital (SD) cards, Universal Serial Bus (USB), Serial Advanced Technology Attachment (SATA), solid-state drive (SSD), and so on. Further, the memory module 203 may include one or more computer-readable storage media. The memory module 203 may include one or more non-volatile storage elements. Examples of such non-volatile storage elements may include Random Access Memory (RAM), Read Only Memory (ROM), magnetic hard discs, optical discs, floppy discs, flash memories, or forms of electrically programmable memories (EPROM) or electrically erasable and programmable (EEPROM) memories. In addition, the memory module 203 may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that may, over time, change (e.g., in Random Access Memory (RAM) or cache).

The term ‘scheduling module 201,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. For example, the scheduling module 201 may include at least one of, a single processer, a plurality of processors, multiple homogeneous or heterogeneous cores, multiple Central Processing Units (CPUs) of different kinds, microcontrollers, special media, and other accelerators.

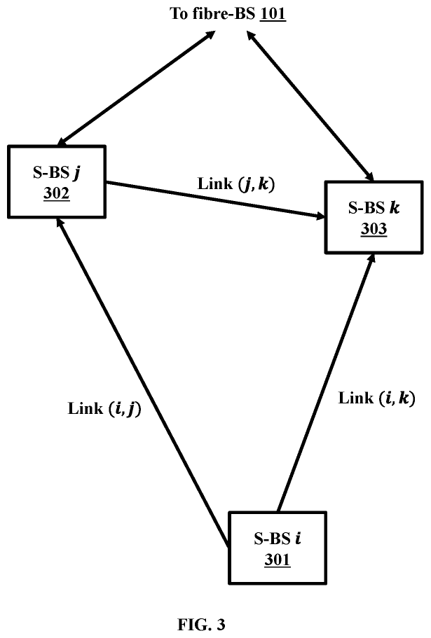

At the beginning of a time slot, all links (i, j), where i and j are neighbours, are in the “pending” state. In the example scenario, depicted in FIG. 3, S-BS k 303 is neighbouring S-BS i 301 and S-BS j 302. Consider that FIG. 2 depicts the S-BS i 301. The scheduling module 201 of S-BS i 301 may only transmit to S-BS j 302 if the distance from S-BS i 301 to the fibre-BS 101 is greater than the distance from S-BS j 302 to the fibre-BS 101 (i.e., hᵢ>hⱼ). So, if the distance from S-BS i 301 to the fibre-BS 101 is less than or equal to the distance from S-BS j 302 to the fibre-BS 101 (i.e., hᵢ≤hⱼ), then the scheduling module 201 can deactivate the link between the S-BS i 301 and the S-BS j 302 (i.e., link (i, j). If hᵢ>hⱼ, then the scheduling module 201 can assign the following weight to the link (i, j):

$${w}_{ij} = {X}_{i} ( {h}_{i} - {h}_{j} ) {log}_{2} ( 1 + {s}_{ij} ) . \qquad ( 1 )$$

where wᵢⱼ denotes the weight assigned to the link (i, j). Similarly, the S-BS j 302 can compute the weights assigned to the links (j, k) and (j, i) using equation (1).

The weight of a link between two BSs 102 is the product of the queue length at an originating BS 301, a difference between the distance from the originating BS 301 to the fibre-BS 101 and the distance from an intermediate BS 302/303 to the fibre-BS and a data rate at which the originating BS 301 can transmit to the intermediate BS 302/303 (i.e., Shannon capacity of the link between the originating BS 301 and the intermediate BS 302/303).

In an example herein, consider that the originating BS 301 is node i 301 and the intermediate node is node j 302. The weight wᵢⱼ assigned to link (i, j) is the product of the queue length at node i 301, a difference between the distance from node i 301 to the fibre-BS 101 and the distance from node j 302 to the fibre-BS 101, and a data rate at which node i 301 can transmit to node j 302 (Shannon capacity of link (i,j)).

Similarly, the S-BS k 303 can compute the weights assigned to the links (k, j) and (k, i) using equation (1).

The scheduling module 201 can activate the link (i, j) in the slot if one of the following four conditions is satisfied for every neighbour S-BS k 303 of S-BS i 301 (i.e., neighbours other than S-BS j 302) and for every neighbour S-BS k 303 of S-BS j 302 (i.e., neighbours other than S-BS i 301):
(i) wᵢⱼ>wᵢₖ or wᵢⱼ=wᵢₖ and j>k (i.e., j denotes a unique identifier of node j and k denotes a unique identifier of node k. So the term “j>k” means that the unique identifier of node j is greater than the unique identifier of node k) or link (i, k) (i.e., the link between the S-BS i 301 and the S-BS k 303) is deactivated,
(ii) wᵢⱼ>wₖᵢ or wᵢⱼ=wₖᵢ and j>k (i.e., unique identifier of node j is greater than the unique identifier of node k) or link (k, i) (i.e., the link between the S-BS k 301 and the S-BS i 303) is deactivated,
(iii) wᵢⱼ>wₖⱼ or wᵢⱼ=wₖⱼ and i>k (i.e., unique identifier of node i is greater than the unique identifier of node k) or link (k, j) (i.e., the link between the S-BS k 303 and the S-BS j 302) is deactivated, and
(iv) wᵢⱼ>wⱼₖ or wᵢⱼ=wⱼₖ and i>k (i.e., unique identifier of node i is greater than the unique identifier of node k) or link (j, k) (i.e., the link between the S-BS j 302 and the S-BS k 303) is deactivated;
where
wᵢₖ denotes the weight assigned to the link (i, k);
wₖᵢ denotes the weight assigned to the link (k, i);
wₖⱼ denotes the weight assigned to the link (k, j); and
wⱼₖ denotes the weight assigned to the link (j, k).

Once the scheduling module 201 activates the link (i, j), then the scheduling module 201 can inform the node j 302 that the link (i, j) is activated through the communication module 302. Also, the scheduling module 201 can deactivate each link of the form (i, k), where, k≠j, (k, i), (k, j), where k≠i, and (j, k), and inform the node k 303 about this deactivation.

Next, if a link (i, j) is in the “pending” state, then the scheduling module 201 can repeat the procedure (as described in the two preceding paragraphs) on a link incident upon node i 301 or node j 302 being deactivated. Also, the scheduling module 201 can deactivate each link of the form (i, k), where, k≠j, (k, i), (k, j), where k≠i, and (j, k) and inform the node k 303 about this deactivation.

The scheduling module 201 can continue until each link is either in the “activated” or “deactivated” state.

After the procedure ends, the scheduling module 201 can consider the set of links that are in the “activated” state as matching, and the scheduling module 201 can transmit the packets on each activated link to the respective BSs in the time slot over the communication module 302.

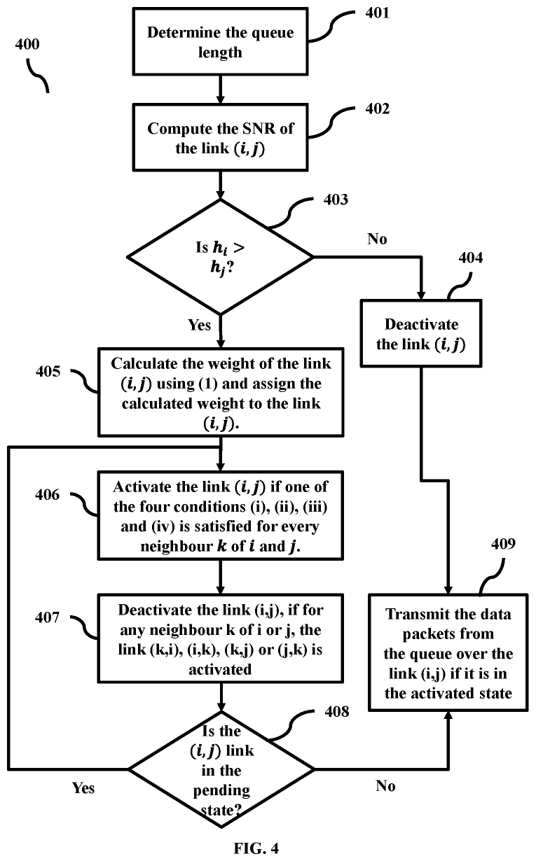

FIG. 4 is a flowchart depicting the process of scheduling the self-backhaul links in millimeter wave networks. At each S-BS i, in step 401, the S-BS i 102 determines the queue length Xᵢ, wherein the queue length is the number of packets currently queuing at the S-BS i 102. In step 402, the S-BS i 102 computes the Signal to Noise Ratio (SNR) of the link (i, j), wherein the SNR of the link (i, j) is denoted by sᵢⱼ. Consider that each link (i, j) is in the pending state at the start of a time slot. In step 403, the S-BS i 102 checks if the distance from S-BS i 301 to the fibre-BS 101 is greater than the distance from S-BS j 302 to the fibre-BS 101 (i.e., hᵢ>hⱼ). If the distance from S-BS i 301 to the fibre-BS 101 is not greater than the distance from S-BS j 302 to the fibre-BS 101, then in step 404, the S-BS i 102 deactivates the link (i, j). If the distance from S-BS i 301 to the fibre-BS 101 is greater than the distance from S-BS j 302 to the fibre-BS 101, then in step 405, the S-BS i 102 calculates the weight wᵢⱼ of the link (i, j) using equation (1) and assigns the calculated weight to the link (i, j). In step 406, the S-BS i 102 activates the link (i, j) if one of the four conditions (i), (ii), (iii) and (iv) is satisfied for every neighbour k of i and j. If for any neighbour k of i or j, the link (k, i), (i, k), (k, j) or (j, k) is activated, in step 407, the S-BS i 102 deactivates the link (i, j). In step 408, the S-BS i 102 checks if the (i, j) link is in the “pending” state. If the (i, j) link is in the “pending” state, then S-BS i 102 repeats the process from step 406 onwards. If the (i, j) link is not in the “pending” state, in step 409, the S-BS i 102 transmits the data packets from the queue over the link (i, j) (if the link (i, j) is in the activated state), wherein the S-BS j 302 can further forward the received packets to the fibre-BS 101 directly or through at least one other S-BS (102). The various actions in method 400 may be performed in the order presented, in a different order or simultaneously. Further, in some embodiments, some actions listed in FIG. 4 may be omitted.

The embodiments disclosed herein can be implemented through at least one software program running on at least one hardware device and performing network management functions to control the network elements. The network elements shown in FIGS. 1, 2 and 3 include blocks which can be at least one of a hardware device, or a combination of hardware device and software module.

The embodiment disclosed herein describes methods and systems for scheduling in mmWave self-backhaul networks with low latency, which considers the arrival and departure of packets in the queue at each of the BSs. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

### STATEMENT OF CLAIMS

We claim:

1. A self-backhauled Base Station (BS) (S-BS) (102) comprising:
a scheduling module (201); and
a memory (203);
wherein the scheduling module (201) is configured for:
determining a queue length at the S-BS (102);
computing a Signal to Noise Ratio (SNR) of a link between the S-BS (102) and at least one other first S-BS;
assigning a weight to the link between the S-BS (102) and the at least one other first S-BS, if a distance between the S-BS (102) and a fibre-BS (101) is greater than a distance between the at least one other first S-BS and the fibre-BS (101);
activating the link between the S-BS (102) and the at least one other first S-BS, if one of
the weight assigned to the link between the S-BS (102) and the at least one other first S-BS is greater than or equal to a weight of a link between the S-BS (102) and all other neighbouring S-BSs of the S-BS (102);
the link between the S-BS (102) and all the other neighbouring S-BSs of the S-BS (102) has been deactivated;
the weight assigned to the link between the S-BS (102) and the at least one other first S-BS is greater than or equal to a weight of a link between the at least one other first S-BS and all the other neighbouring S-BSs of the S-BS (102); or
the link between the at least one other first S-BS and all the other neighbouring S-BSs of the S-BS (102) has been deactivated; and
transmitting packets from the queue over the link between the S-BS (102) and the at least one other first S-BS.

2. The self-backhauled Base Station (BS) (S-BS), as claimed in claim 1, wherein the scheduling module (201) is further configured for deactivating the link between the S-BS (102) and the at least one other first S-BS, if the distance between the S-BS (102) and a fibre-BS (101) is not greater than the distance between the at least one other first S-BS and the fibre-BS (101).

3. The self-backhauled Base Station (BS) (S-BS), as claimed in claim 1, wherein the scheduling module (201) is further configured for calculating the weight as a product of
a queue length at the S-BS (102);
a difference between the distance from the S-BS (102) to the fibre-BS (101) and the distance between the at least one other first S-BS and the fibre-BS (101); and
Shannon capacity of the link between the S-BS (102) and the at least one other first S-BS.

4. The self-backhauled Base Station (BS) (S-BS), as claimed in claim 1, wherein the scheduling module (201) is further configured for checking if the link between the S-BS (102) and the at least one other first S-BS is in a pending state.

5. A method for scheduling of self-backhaul links in millimeter wave networks, wherein the method further comprises:
determining, by a self-backhauled Base Station (BS) (S-BS) (102), a queue length at the S-BS (102);
computing, by the S-BS (102), a Signal to Noise Ratio (SNR) of a link between the S-BS (102) and at least one other first S-BS;
assigning, by the S-BS (102), a weight to the link between the S-BS (102) and the at least one other first S-BS, if a distance between the S-BS (102) and a fibre-BS (101) is greater than a distance between the at least one other first S-BS and the fibre-BS (101);
activating, by the S-BS (102), the link between the S-BS (102) and the at least one other first S-BS, if one of
the weight assigned to the link between the S-BS (102) and the at least one other first S-BS is greater than or equal to a weight of a link between the S-BS (102) and all other neighbouring S-BSs of the S-BS (102);
the link between the S-BS (102) and all the other neighbouring S-BSs of the S-BS (102) has been deactivated;
the weight assigned to the link between the S-BS (102) and the at least one other first S-BS is greater than or equal to a weight of a link between the at least one other first S-BS and all the other neighbouring S-BSs of the S-BS (102); or
the link between the at least one other first S-BS and all the other neighbouring S-BSs of the S-BS (102) has been deactivated; and
transmitting packets, by the S-BS (102), from the queue over the link between the S-BS (102) and the at least one other first S-BS.

6. The method, as claimed in claim 5, wherein the method further comprises deactivating the link between the S-BS (102) and the at least one other first S-BS, if the distance between the S-BS (102) and a fibre-BS (101) is not greater than the distance between the at least one other first S-BS and the fibre-BS (101).

7. The method, as claimed in claim 5, wherein the weight is a product of
a queue length at the S-BS (102);
a difference between the distance from the S-BS (102) to the fibre-BS (101) and the distance between the at least one other first S-BS and the fibre-BS (101); and
Shannon capacity of the link between the S-BS (102) and the at least one other first S-BS.

8. The method, as claimed in claim 5, wherein the method further comprises checking if the link between the S-BS (102) and the at least one other first S-BS is in a pending state.

9. The method, as claimed in claim 5, wherein the method further comprises forwarding the received packets, by the at least one other first S-BS to the fibre-BS 101 directly or through at least one other S-BS.
